(19) United States
(12) Patent Application Publication
(10) Pub. No.: US 2016/0019010 A1
(43) Pub. Date: Jan. 21, 2016

(54) Device Management System That Ensure Improved Convenience, Device Management Apparatus, and Device Management Method

(71) Applicant: Kyocera Document Solutions Inc., Osaka (JP)

(72) Inventors: Takeshi Nakamura, Osaka (JP); Takashi Nomura, Osaka (JP); Yuichi Obayashi, Osaka (JP); Chika Tsuji, Osaka (JP); Jumpei Takagi, Osaka (JP); Katsuhiro Minoru, Osaka (JP); Daisuke Yoshida, Osaka (JP)

(21) Appl. No.: 14/752,882

(22) Filed: Jun. 27, 2015

(30) Foreign Application Priority Data
Jun. 27, 2014 (JP) 2014-133228

(51) Int. Cl. G06F 3/12

(52) U.S. Cl. CPC G06F 3/1226; G06F 3/1204; G06F 3/1288

(57) ABSTRACT

A device management apparatus includes a set content collection circuit and a set content notification circuit. The set content collection circuit collects set contents of a plurality of electronic devices. The set content notification circuit notifies the set contents collected by the set content collection circuit. The set content notification circuit notifies a specific number of set contents with highest ranks in counts of electronic devices having an identical set content.

### INCORPORATION BY REFERENCE

This application is based upon, and claims the benefit of priority from, corresponding Japanese Patent Application No. 2014-133228 filed in the Japan Patent Office on Jun. 27, 2014, the entire contents of which are incorporated herein by reference.

### BACKGROUND

Unless otherwise indicated herein, the description in this section is not prior art to the claims in this application and is not admitted to be prior art by inclusion in this section.

As a typical device management system that controls a plurality of electronic devices, there is known a device management system that collects set contents of a plurality of electronic devices by one server.

### SUMMARY

A device management apparatus according to an aspect of the disclosure includes a set content collection circuit and a set content notification circuit. The set content collection circuit collects set contents of a plurality of electronic devices. The set content notification circuit notifies the set contents collected by the set content collection circuit. The set content notification circuit notifies a specific number of set contents with highest ranks in counts of electronic devices having an identical set content.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 illustrates a device management system according to an embodiment of the disclosure.

FIG. 2 illustrates a configuration of the device management apparatus according to the embodiment.

FIG. 3 illustrates a configuration of a cloud server according to the embodiment.

FIG. 4 illustrates a configuration of a portable terminal according to the embodiment.

FIG. 5 illustrates a performance of the device management system according to the embodiment when configuring an initial setting to an image forming apparatus.

FIG. 6 illustrates a performance of the device management system according to the embodiment when configuring a setting to an image forming apparatus in an office having a remote maintenance contract.

FIG. 7 illustrates a performance of the device management system according to the embodiment when configuring a setting to an image forming apparatus in an office not having a remote maintenance contract.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

The following describes an embodiment of the disclosure with reference to the drawings.

First, a configuration of a device management system 10 according to the embodiment will be described.

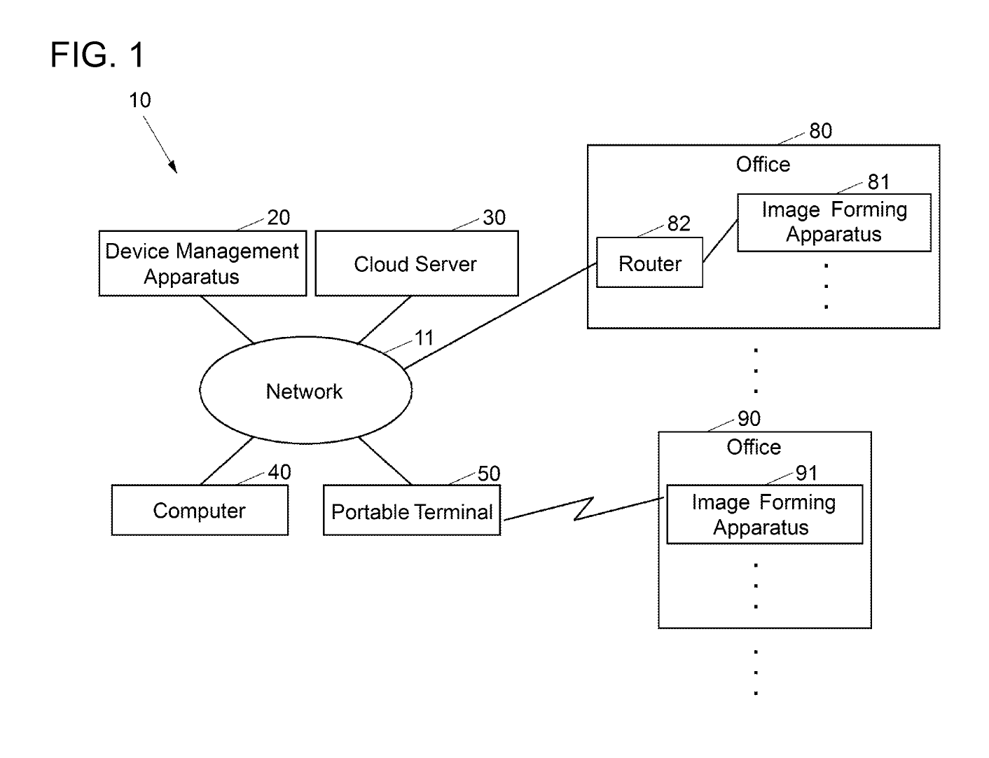

FIG. 1 illustrates the device management system 10 according to the embodiment.

As illustrated in FIG. 1, the device management system 10 is a system that controls a plurality of image forming apparatuses as electronic devices. The image forming apparatus includes the electronic device such as a multifunction peripheral (MFP) and a printer-only machine, for example. The plurality of the image forming apparatuses are each installed in an office. Here, the office includes an office 80 having a remote maintenance contract and an office 90 not having a remote maintenance contract. The remote maintenance contract is a contract that set contents of the image forming apparatus owned by the office is set by a serviceman via a network 11 such as Internet.

The office 80 includes a plurality of the image forming apparatuses such as an image forming apparatus 81 and a router 82, which connects the image forming apparatuses to the network 11. The office 90 includes a plurality of the image forming apparatuses such as an image forming apparatus 91.

The device management system 10 can control not only the image forming apparatus in the office 80, but also the image forming apparatus in the other office having the remote maintenance contract. Similarly, the device management system 10 can control not only the image forming apparatus in the office 90, but also the image forming apparatus in the other office not having the remote maintenance contract. The device management system 10 can control the image forming apparatuses installed all over the world.

The device management system 10 includes a device management apparatus 20, a cloud server 30, a computer 40, and a portable terminal 50. The device management apparatus 20 controls a plurality of the image forming apparatuses. The cloud server 30 stores set contents of a plurality of the image forming apparatuses. The computer 40 is such as a personal computer (PC) that is used by the serviceman who configures the setting of the image forming apparatus via the network 11. The portable terminal 50 is such as a smart phone that is used by the serviceman who configures the setting of the image forming apparatus not via the network 11.

The computer 40 is installed in a place apart from the office having the remote maintenance contract.

A performance mode of the image forming apparatus managed by the device management system 10 includes a normal mode and a maintenance mode. The normal mode is for the ordinary performance used by a general user, and the maintenance mode is exclusive for the maintenance used by limited users such as the servicemen.

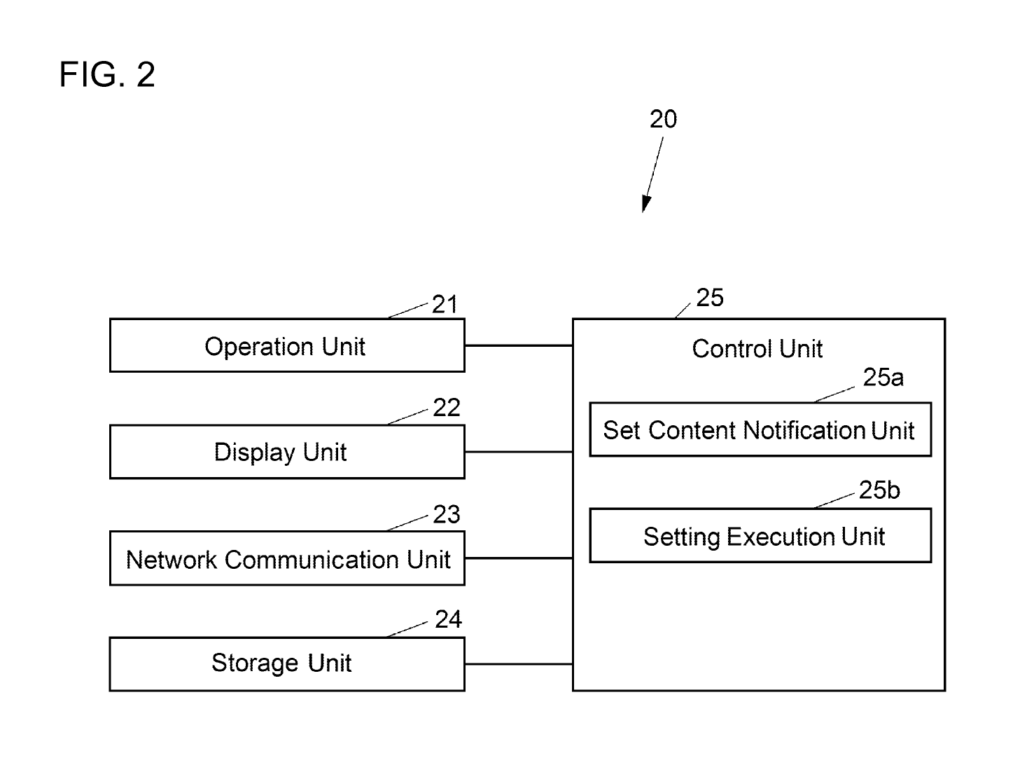

FIG. 2 illustrates the device management apparatus 20.

As illustrated in FIG. 2, the device management apparatus 20 includes an operation unit 21, a display unit 22, a network communication unit 23, a storage unit 24, and a control unit 25. The operation unit 21 is an input device that includes a circuit such as a computer mouse and a keyboard for inputting various operations. The display unit 22 is a display device that includes a circuit such as a liquid crystal display (LCD) that displays various kinds of information. The network communication unit 23 is a network communication device that includes a circuit that communicates with an external device via the network 11 (see FIG. 1). The storage unit 24 is a non-volatile recording medium, which is non-transitory computer-readable, that includes a circuit such as a hard disk drive (HDD) that stores programs and various data. The control unit 25 is a processor that includes a circuit that controls the entire device management apparatus 20. The device management apparatus 20 is constituted of a computer such as PC for example.

The control unit 25 includes, for example, a central processing unit (CPU), a read only memory (ROM), which stores programs and various data, and a random access memory (RAM), which is employed as a work area for the CPU. The CPU can run the program stored in the ROM or the storage unit 24.

The control unit 25 runs the program stored in the ROM or the storage unit 24 to functions as a set content notification unit 25a (which is also referred to as “set content notification circuit”), which notifies the set content collected by the cloud server 30 (see FIG. 1), and a setting execution unit 25b (which is also referred to as “setting execution circuit”), which configures the settings for the target image forming apparatus.

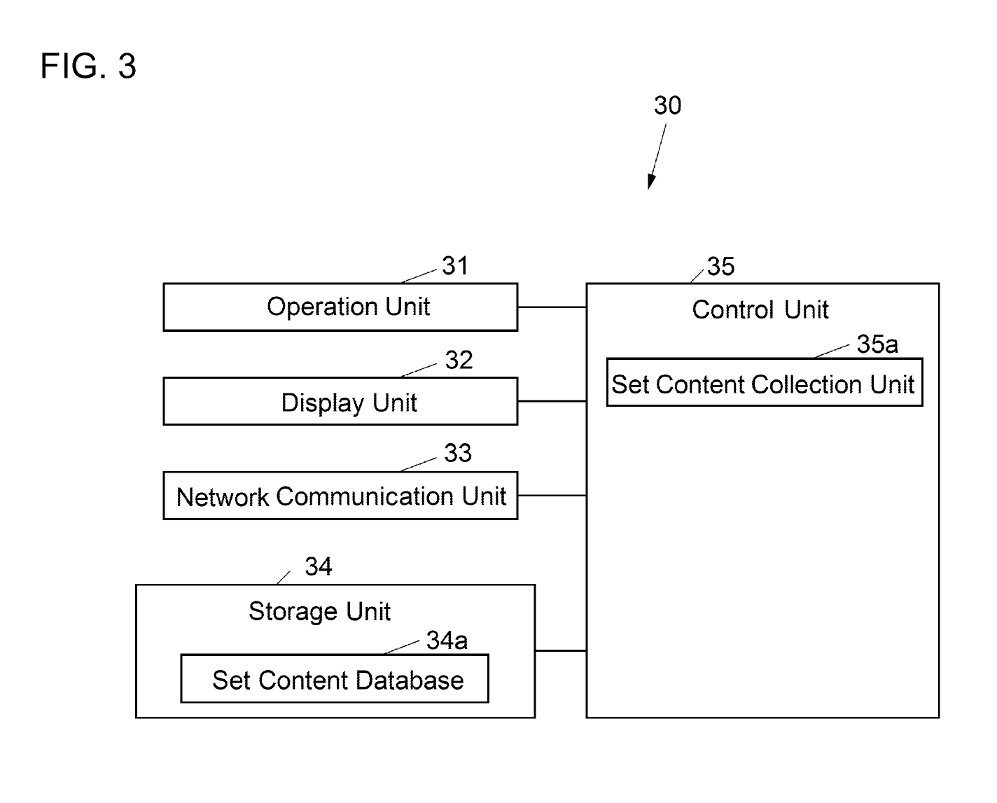

FIG. 3 illustrates the cloud server 30.

As illustrated in FIG. 3, the cloud server 30 includes an operation unit 31, a display unit 32, a network communication unit 33, a storage unit 34, and a control unit 35. The operation unit 31 is an input device that includes a circuit such as a computer mouse and a keyboard for inputting various operations. The display unit 32 is a display device that includes a circuit such as the LCD that displays various kinds of information. The network communication unit 33 is a network communication device that includes a circuit that communicates with an external device via the network 11 (see FIG. 1). The storage unit 34 is a non-volatile storage device that includes a circuit such as the HDD that stores programs and various data. The control unit 35 is a processor that includes a circuit for controlling the entire cloud server 30. The cloud server 30 is constituted of a computer such as PC for example.

The storage unit 34 stores a set content database 34a that includes the set contents of the respective image forming apparatuses.

The set content database 34a includes information that associates identification information of the image forming apparatus, an attribution of the image forming apparatus, the set contents of the image forming apparatus, and date and time set in the set contents (hereinafter referred to as “setting date and time”) with each of the respective image forming apparatuses.

Here, the attribution may include, for example, device information of the image forming apparatus, installation location information of the image forming apparatus, and usage environment information of the image forming apparatus.

For example, the device information of the image forming apparatus may include information of an A3 device, which supports A3 size as the maximum paper sheet size, an A4 device, which supports A4 size as the maximum paper sheet size, a color printing machine, which supports color printing among monochrome printing and color printing, a monochrome printing machine, which supports monochrome printing only among monochrome printing and color printing, a model name of the image forming apparatus, and similar information.

The installation location information of the image forming apparatus may include temperature, humidity, and altitude of the installation location of the image forming apparatus and country and region where the image forming apparatus is installed.

For example, the usage environment information of the image forming apparatus may include whether or not the image forming apparatus is used in a common office, whether or not the image forming apparatus is used in a plant, whether or not the image forming apparatus is used for the print job from a main frame, and for which business type the image forming apparatus is used.

The control unit 35 includes, for example, a CPU, a ROM, which stores program and various data, a RAM, which is employed as a work area for the CPU. The CPU can run the program stored in the ROM or the storage unit 34.

The control unit 35 runs the program stored in the ROM or the storage unit 34 to functions as a set content collection unit 35a (which is also referred to as set content collection circuit), which collects the set contents of a plurality of the image forming apparatuses.

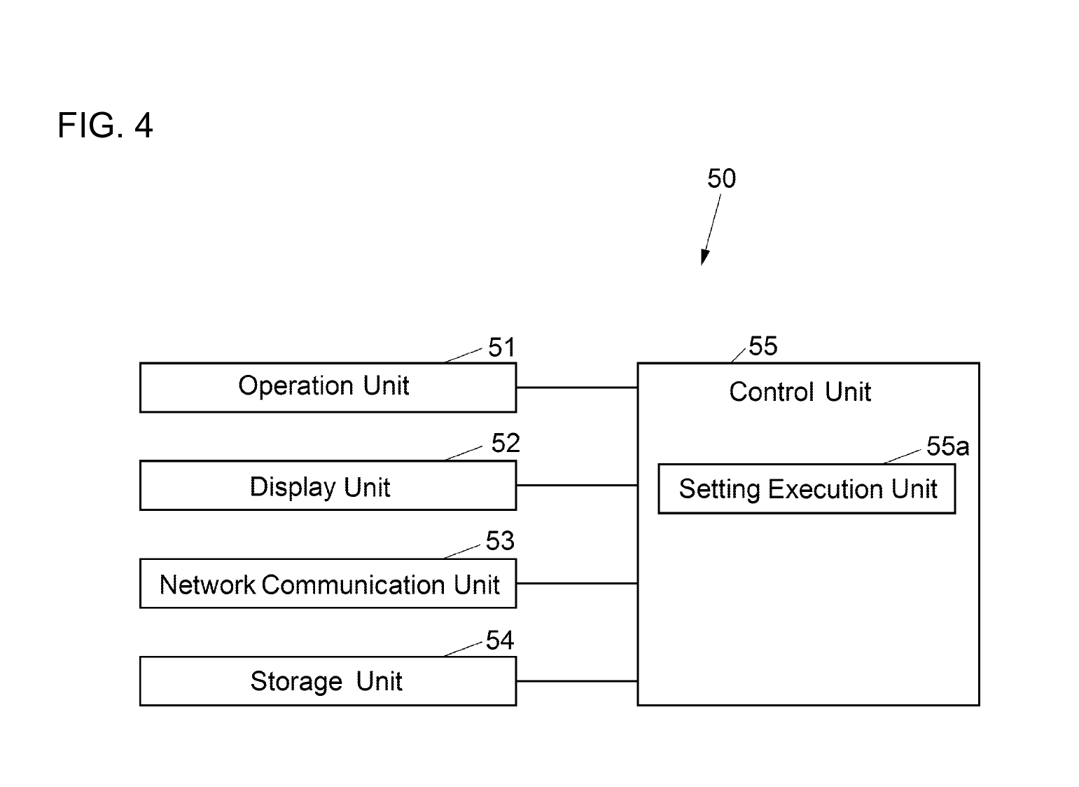

FIG. 4 illustrates the portable terminal 50.

As illustrated in FIG. 4, the portable terminal 50 includes an operation unit 51, a display unit 52, a network communication unit 53, a storage unit 54, and a control unit 55. The operation unit 51 is an input device that includes a circuit such as a button for inputting various kinds of operations. The display unit 52 is a display device that includes a circuit such as the LCD that displays various kinds of information. The network communication unit 53 is a network communication device that includes a circuit that communicates with an external device via the network 11 (see FIG. 1). The storage unit 54 is a non-volatile storage device that includes a circuit such as an electrically erasable programmable read only memory (EEPROM) and a HDD that stores programs and various data. The control unit 55 is a processor that includes a circuit for controlling the entire portable terminal 50.

The control unit 55 includes, for example, a CPU, a ROM, which stores the program and various data, and a RAM, which is employed as the work area for the CPU. The CPU can run the program stored in the ROM or the storage unit 54.

The control unit 55 runs the program stored in the ROM or the storage unit 54 to function as a setting execution unit 55a (also referred to as setting execution circuit), which configures the settings for the target image forming apparatus.

The control unit 55 can be connected temporarily to the image forming apparatus in the office 90 using the network communication unit 53 via the network such as a local area network (LAN) in the office 90. The method for the connection may be wireless or wired.

Next, a performance of the device management system 10 will be described.

First, a description will be given of the performance of the device management system 10 when configuring an initial setting to the image forming apparatus.

Hereinafter, while a description will be given of the image forming apparatus 81, the other image forming apparatus such as the image forming apparatus 91 performs similarly.

The serviceman logs in the maintenance mode of the image forming apparatus 81 via the operation unit of the image forming apparatus 81. Then, the serviceman, who has logged in the maintenance mode of the image forming apparatus 81, instructs the change of the setting that can be changed only in the maintenance mode among the normal mode and the maintenance mode via the operation unit of the image forming apparatus 81.

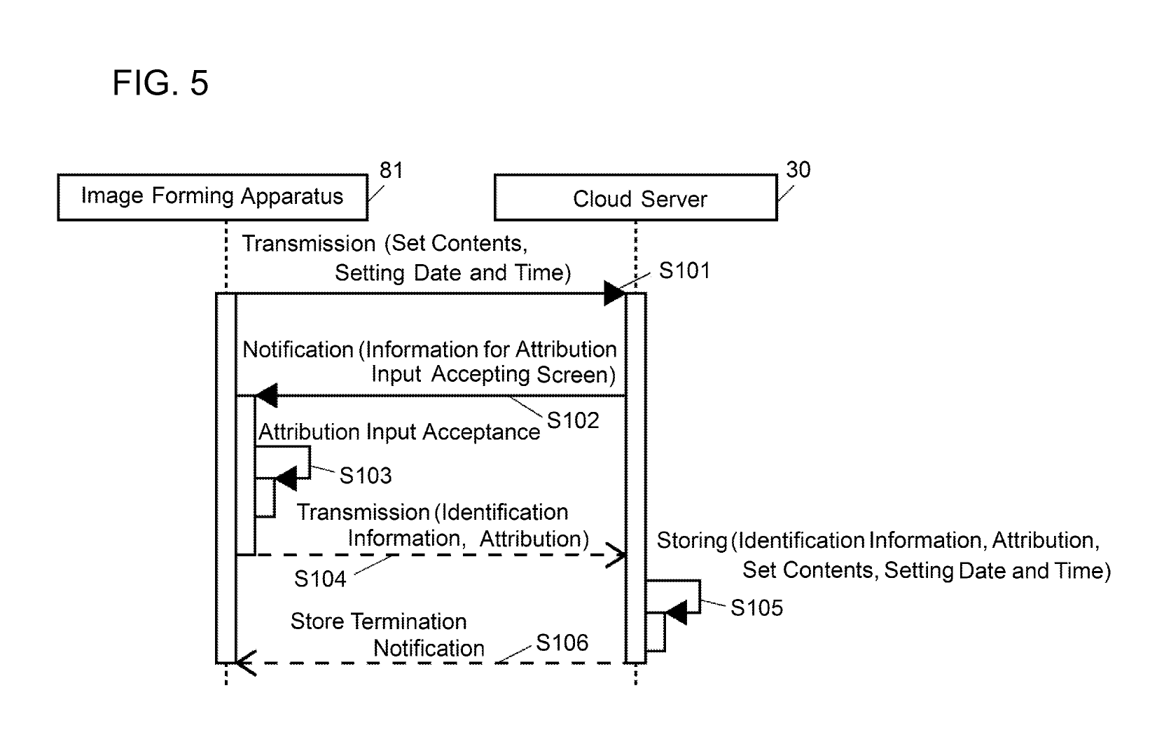

FIG. 5 illustrates the performance of the device management system 10 when configuring the initial setting to the image forming apparatus.

As illustrated in FIG. 5, when the change of the setting is instructed via the operation unit, the image forming apparatus 81 make the setting as instructed. Then, the image forming apparatus 81 transmits the set contents and the setting date and time to the set contents via the network 11 to the cloud server 30 (Step S101).

The set content collection unit 35a of the cloud server 30 receives the set content and the setting date and time, which is transmitted from the image forming apparatus 81 at Step S101, via the network communication unit 33. Then, the set content collection unit 35a notifies the image forming apparatus 81 of information on an attribution input accepting screen for accepting the input of the attribution of the image forming apparatus 81 (hereinafter referred to as “information for the attribution input accepting screen”) via the network communication unit 33 (Step S102).

Receiving the information on the attribution input accepting screen notified from the cloud server 30 at Step S102, the image forming apparatus 81 displays an attribution input accepting screen, which is based on the received information on the attribution input accepting screen, on the display unit to accept the input of the attribution of the image forming apparatus 81 (Step S103).

When the attribution input accepting screen is displayed on the display unit of the image forming apparatus 81, the serviceman inputs the attribution of the image forming apparatus 81 on the displayed attribution input accepting screen via the operation unit of the image forming apparatus 81.

Accepting the input of the attribution of the image forming apparatus 81 at Step S103, the image forming apparatus 81 transmits the accepted attribution and the identification information of the image forming apparatus 81 to the cloud server 30 via the network 11 (Step S104).

The set content collection unit 35a of the cloud server 30 receives the identification information and attribution, which is transmitted from the image forming apparatus 81 at Step S104, via the network communication unit 33. Then, the set content collection unit 35a associates the received identification information and attribution with the set content and setting date and time, which have been transmitted from the image forming apparatus 81 at Step S101, to store them in the set content database 34a (Step S105).

Next, the set content collection unit 35a notifies the image forming apparatus 81 of the termination of storing the set contents via the network communication unit 33 (Step S106) and then terminates the performance illustrated in FIG. 5.

Next, a description will be given of the performance of the device management system 10 when configuring the settings for the image forming apparatus installed in the office having the remote maintenance contract.

Hereinafter, a description will be given of the image forming apparatus 81. However, the other image forming apparatus performs similarly insofar as the image forming apparatus is installed in the office having the remote maintenance contract.

The serviceman gives an instruction to the computer 40, which is installed in the place apart from the office 80, to log in the maintenance mode of the image forming apparatus 81 via the operation unit of the computer 40.

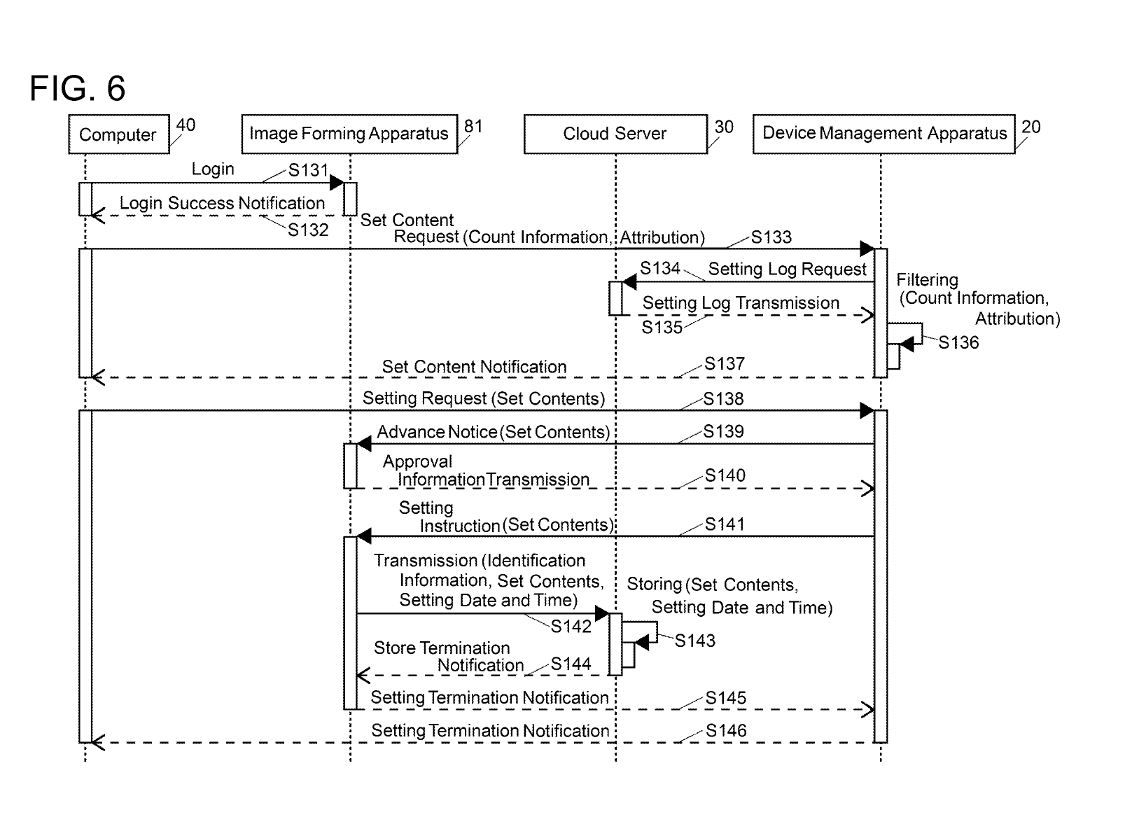

FIG. 6 illustrates the performance of the device management system 10 when configuring the settings for the image forming apparatus installed in the office having the remote maintenance contract.

As illustrated in FIG. 6, when the login to the maintenance mode of the image forming apparatus 81 is instructed, the computer 40 logs in the maintenance mode of the image forming apparatus 81 via the network 11 (Step S131).

With the successful login at Step S131, the image forming apparatus 81 notifies the computer 40 of the successful login via the network 11 (Step S132).

When the successful login to the maintenance mode of the image forming apparatus 81 is notified from the image forming apparatus 81, the computer 40 displays the successful login to the maintenance mode of the image forming apparatus 81 on the display unit of the computer 40 itself. Accordingly, the serviceman can recognize the successful login to the maintenance mode of the image forming apparatus 81 via the display unit of the computer 40.

The serviceman, who has logged in the maintenance mode of the image forming apparatus 81, can instruct to display the set contents set in many of the image forming apparatuses to the computer 40. When the display of the set contents, which are set in many of the image forming apparatuses, is instructed, the computer 40 requests the set contents, which are set in many of the image forming apparatuses, to the device management apparatus 20 via the network 11 (Step S133). The request at Step S133 includes information (hereinafter referred to as “number information”) and the attribution for filtering the set contents. This information indicates how many set contents with highest ranks to be displayed in the counts of the image forming apparatuses having the identical set content. Here, the number information and the attribution are input via the operation unit of the computer 40.

Receiving the request for the set contents from the computer 40 via the network communication unit 23, the set content notification un it 25a of the device management apparatus 20 requests a setting log, namely, all the attribution and set contents of the image forming apparatuses included in the set content database 34a to the cloud server 30 via the network communication unit 23 (Step S134).

Receiving the request for the setting log from the device management apparatus 20 via the network communication unit 33, the cloud server 30 transmits the setting log to the device management apparatus 20 via the network communication unit 33 (Step S135).

Receiving the setting log from the cloud server 30 via the network communication unit 23, the set content notification unit 25a of the device management apparatus 20 filters the set contents included in the received setting log based on the number information and attribution received at Step S133 (Step S136). Specifically, the set content notification unit 25a extracts the set contents of the image forming apparatuses that satisfy the attribution received at Step S133 in descending order of the counts of the image forming apparatuses. The set content notification unit 25a extracts the set contents, the number of which corresponds to the number information received at Step S133, for example, 10 of the set contents.

Then, the set content notification unit 25a notifies the computer 40 of the set contents extracted at Step S136 via the network communication unit 23 (Step S137).

When the set contents extracted at Step S136 are notified from the device management apparatus 20 via the network 11, the computer 40 displays the notified set contents on the display unit of the computer 40 itself. Accordingly, the serviceman can recognize the set contents extracted at Step S136 via the display unit of the computer 40. Then, the serviceman can specify the set contents that the serviceman determined necessary to the image forming apparatus 81 among the set contents displayed on the display unit of the computer 40 via the operation unit of the computer 40. When the set content is specified, the computer 40 requests the setting with the specified set content to the device management apparatus 20 via the network 11 (Step S138).

Receiving the request for setting via the network communication unit 23, the setting execution unit 25b of the device management apparatus 20 transmits an advance notice of the setting with the specified set content to the image forming apparatus 81 via the network communication unit 23 (Step S139).

Receiving the advance notice transmitted at Step S139 via the network 11, the image forming apparatus 81 displays the received advance notice on the display unit of the image forming apparatus 81 itself to accept approval by the user. Here, the image forming apparatus 81 may display the advance notice on the display unit of the image forming apparatus 81 itself only when the image forming apparatus 81 is used by the administrator among the users of the image forming apparatus 81. Then, when the image forming apparatus 81 accepts the approval by the user via the operation unit of the image forming apparatus 81 itself, the image forming apparatus 81 transmits approval information indicating the approval to the device management apparatus 20 via the network 11 (Step S140).

Receiving the approval information transmitted at Step S140 via the network communication unit 23, the setting execution unit 25b of the device management apparatus 20 instructs the setting as required at Step S138 to the image forming apparatus 81 via the network communication unit 23 (Step S141).

Accepting the instruction at Step S141 via the network 11, the image forming apparatus 81 sets the set content as instructed at Step S141. Subsequently, the image forming apparatus 81 transmits this set content, the setting date and time of this set content, and the identification information of the image forming apparatus 81 itself to the cloud server 30 via the network 11 (Step S142).

Receiving the identification information, the set contents, and the setting date and time, which are transmitted from the image forming apparatus 81 at Step S142, via the network communication unit 33, the set content collection unit 35a of the cloud server 30 stores the received set contents and setting date and time, as the set contents and setting date and time of the image forming apparatus 81 based on the received identification information, in the set content database 34a (Step S143).

Next, the set content collection unit 35a notifies the image forming apparatus 81 of the termination of storing the set contents via the network communication unit 33 (Step S144).

When the termination of storing the set contents is notified from the cloud server 30, the image forming apparatus 81 notifies the device management apparatus 20 of the termination of setting via the network 11 (Step S145).

When the termination of setting is notified from the image forming apparatus 81, the setting execution unit 25b of the device management apparatus 20 notifies the computer 40 of the termination of setting via the network communication unit 33 (Step S146) and then terminates the performance illustrated in FIG. 6.

Next, a description will be given of the performance of the device management system 10 when configuring the settings for the image forming apparatus installed in the office not having the remote maintenance contract.

Hereinafter, while a description will be given of the image forming apparatus 91, the other image forming apparatus performs similarly insofar as the image forming apparatus is installed in the office not having the remote maintenance contract.

The serviceman goes to the office 90 carrying the portable terminal 50. Then, the serviceman instructs the portable terminal 50 to log in the maintenance mode of the image forming apparatus 91 via the operation unit 51 of the portable terminal 50.

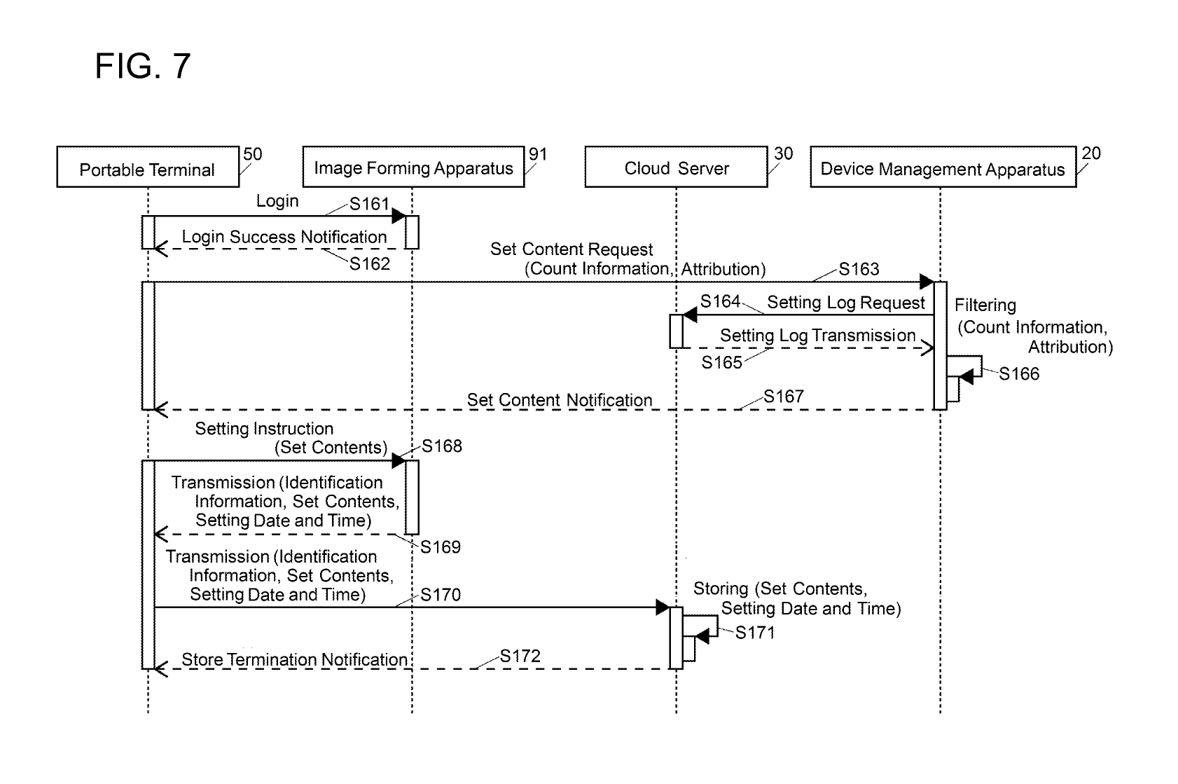

FIG. 7 illustrates the performance of the device management system 10 when configuring the settings for the image forming apparatus installed in the office not having the remote maintenance contract.

As illustrated in FIG. 7, when the instruction to log in the maintenance mode of the image forming apparatus 91 is given, the portable terminal 50 logs in the maintenance mode of the image forming apparatus 91 via the network communication unit 53 (Step S161).

With the successful login at Step S161, the image forming apparatus 91 notifies the portable terminal 50 of the successful login via the network in the office 90 (Step S162).

When the successful login to the maintenance mode of the image forming apparatus 91 is notified from the image forming apparatus 91, the portable terminal 50 displays the successful login to the maintenance mode of the image forming apparatus 91 on the display unit 52. Accordingly, the serviceman can recognize the successful login to the maintenance mode of the image forming apparatus 91 via the display unit 52.

The serviceman, who has logged in the maintenance mode of the image forming apparatus 91, can instruct to display the set contents that are set in many of the image forming apparatuses to the portable terminal 50. When the display of the set contents, which are set in many of the image forming apparatuses, is instructed, the portable terminal 50 requests the set contents, which are set in many of the image forming apparatuses, to the device management apparatus 20 via the network communication unit 53 (Step S163). The request at Step S163 includes the number information and the attribution for filtering the set contents. Here, the number information and the attribution are input via the operation unit 51 of the portable terminal 50.

Receiving the request for the set contents from the portable terminal 50 via the network communication unit 23, the set content notification unit 25a of the device management apparatus 20 requests a setting log to the cloud server 30 via the network communication unit 23 (Step S164).

Receiving the request for the setting log from the device management apparatus 20 via the network communication unit 33, the cloud server 30 transmits the setting log to the device management apparatus 20 via the network communication unit 33 (Step S165).

Receiving the setting log from the cloud server 30 via the network communication unit 23, the set content notification unit 25a of the device management apparatus 20 filters the set contents included in the received setting log based on the number information and attribution received at Step S163 (Step S166). Specifically, the set content notification unit 25a extracts the set contents of the image forming apparatuses that satisfy the attribution received at Step S163 in descending order of the counts of the image forming apparatuses, and the number of the set contents corresponds to the number information received at Step S163.

Then, the set content notification unit 25a notifies the portable terminal 50 of the set contents extracted at Step S166 via the network communication unit 23 (Step S167).

When the set contents extracted at Step S166 are notified from the device management apparatus 20 via the network communication unit 53, the portable terminal 50 displays the notified set contents on the display unit 52. Accordingly, the serviceman can recognize the set contents extracted at Step S166 via the display unit 52. Then, the serviceman can specify the set content that the serviceman determined necessary to the image forming apparatus 91 among the set contents displayed on the display unit 52 via the operation unit 51 of the portable terminal 50. When the set content is specified, the setting execution unit 55a of the portable terminal 50 instructs the setting with the specified set content to the image forming apparatus 91 via the network communication unit 53 (Step S168).

Accepting the instruction at Step S168 via the network in the office 90, the image forming apparatus 91 sets the set content as instructed at Step S168. Subsequently, the image forming apparatus 91 transmits this set content, the setting date and time of the set content, and the identification information of the image forming apparatus 91 itself to the portable terminal 50 via the network in the office 90 (Step S169).

Receiving the identification information, the set content, and the setting date and time, which are transmitted from the image forming apparatus 91 at Step S169, via the network communication unit 53, the setting execution unit 55a of the portable terminal 50 transmits the received identification information, the set content, and the setting date and time to the cloud server 30 via the network communication unit 53 (Step S170).

Receiving the identification information, the set contents, and the setting date and time, which are transmitted from the portable terminal 50 at Step S170, via the network communication unit 33, the set content collection unit 35a of the cloud server 30 stores the received set contents and setting date and time, as the set contents and setting date and time of the image forming apparatus 91 based on the received identification information, in the set content database 34a (Step S171).

Next, the set content collection unit 35a notifies the portable terminal 50 of the termination of storing the set contents via the network communication unit 33 (Step S172) and then terminates the performance illustrated in FIG. 7.

As described above, the device management system 10 notifies a specific number of set contents with highest ranks in the counts of the image forming apparatuses having an identical set content (Step S136 and Step S137, or Step S166 and Step S167). Then, when the user of the image forming apparatus, such as the serviceman, configures the settings for the image forming apparatus, the device management system 10 can cause the user of the image forming apparatus to recognize which set content is typically set in general. Accordingly, the device management system 10 ensures the improved convenience.

The device management system 10 can cause a plurality of the serviceman to share the set contents that are set with high frequency among the set contents in the maintenance mode of the image forming apparatus. Accordingly, for example, the serviceman recognizes the set contents that are set with high frequency among the set contents in the maintenance mode of the image forming apparatus in advance. This ensures the image forming apparatus as a maintenance target to be set with the set contents corresponding to a problem that is possible to occur in the future to the image forming apparatus as the maintenance target.

For example, assume that a high altitude mode among the set contents in the maintenance mode is set with high frequency to the image forming apparatus installed in a high altitude place. In this case, when the image forming apparatus as the maintenance target is installed in a high altitude place, the serviceman can recognize that the high altitude mode is set with high frequency to the image forming apparatus installed in a high altitude place by the notice from the device management apparatus 20 at Step S137 or Step S167. Accordingly, the serviceman can set the high altitude mode to the image forming apparatus as the maintenance target.

Among the attributions of the image forming apparatus, the altitude is described above. The same applies to the attributions other than the altitude. For example, for the country among the attributions of the image forming apparatuses, assume that setting the installation location of the image forming apparatus to a specific country set the language of the image forming apparatus to a specific language other than English. In this case, when a problem that a status page indicating the status of the image forming apparatus is printed in an abnormal state such as garbled characters occurs, the image forming apparatus may be set to indicate only the status page in English. Accordingly, a plurality of the image forming apparatuses installed in an identical country are considered to share appropriate set contents. For the region among the attribution of the image forming apparatus, it is similar to the country. For the attribution that the image forming apparatus is used in a common office, for example, a consecutive print job is assumed not so much in the common office. Accordingly, a plurality of the image forming apparatuses under such usage environment are considered to share appropriate set contents. For the attribution that the image forming apparatus is used for the print job from the main frame, for example, the print jobs from the main frame are assumed to be almost always executed. Accordingly, a plurality of the image forming apparatuses under such usage environment are considered to share appropriate set contents. For the attribution for the business type where the image forming apparatus is used, for example, when the image forming apparatus is used in a design industry, the users of the image forming apparatuses are assumed to have a preference in color of the printing result by the image forming apparatus. Accordingly, a plurality of the image forming apparatuses under such usage environment are considered to share appropriate set contents.

When the attribution of the image forming apparatus is specified (Step S133 or Step S163), the device management system 10 notifies the set contents associated with the specified attribution (Step S137 or Step S167). This ensures the device management system 10 to narrow down the set contents to notify according to the attribution of the image forming apparatus. Accordingly, when the user of the image forming apparatus configures the settings for the image forming apparatus, the device management system 10 can cause the user of the image forming apparatus to recognize which set content is typically set in general to the image forming apparatus having an identical attribution with the image forming apparatus as the target to configure the setting.

When the device management system 10 requests the set contents that are set in the many image forming apparatuses to the device management apparatus 20, the device management system 10 may be specified a period during which the target set contents are set in the image forming apparatus (hereinafter referred to as “setting period”) in addition to the attribution or instead of the attribution by the user. When the setting period is specified, the device management system 10 can narrow down the appropriate set contents to notify to the user according to the setting period. For example, the device management system 10 can extract the set contents set recently.

When at least one set content is specified among the plurality of set contents notified at Step S137 or Step S167 (Step S138 or Step S168), the device management system 10 configures the settings for the target image forming apparatus with the specified set contents (Step S141 or Step S168). This ensures the device management system 10 to facilitate the work of setting when the user of the image forming apparatus such as the serviceman configures the settings for the image forming apparatus without a complicated operation to the image forming apparatus.

In the device management system 10, the set content set in the performance illustrated in FIGS. 5 to 7 is the content that is settable only in the maintenance mode among the normal mode and the maintenance mode of the image forming apparatus. Accordingly, when the serviceman of the image forming apparatus configures the settings for the image forming apparatus in the maintenance mode, the device management system 10 can cause the serviceman to recognize which set content is typically set in general in the maintenance mode.

In the device management system 10, the set content set in the performance illustrated in FIGS. 5 to 7 may be settable in the normal mode of the image forming apparatus.

The device management system 10 changes the set content to the image forming apparatus in the performance illustrated in FIG. 5 (Step S105). However, in the performance illustrated in FIG. 5, it is enough to store the attribution of the image forming apparatus in the cloud server 30, and it is not necessary for the device management system 10 to change the set content to the image forming apparatus.

While in the performance illustrated in FIG. 5, the device management system 10 receives the attribution of the image forming apparatus via the operation unit of the image forming apparatus, the attribution of the image forming apparatus may receive it via the computer 40 as the performance illustrated in FIG. 6, and may receive it via the portable terminal 50 as the performance illustrated in FIG. 7.

The computer 40 specifies the set content to apply to the target image forming apparatus among the set contents notified from the device management apparatus 20 in the performance illustrated in FIG. 6. However, the computer 40 can configure the setting with any set content to the target image forming apparatus similarly to the performance illustrated in FIG. 5. The device management system 10 stores the set contents in the set content database 34a of the cloud server 30 even when the computer 40 configures the setting with any set content to the target image forming apparatus.

The portable terminal 50 specifies the set content to apply to the target image forming apparatus among the set contents notified from the device management apparatus 20 in the performance illustrated in FIG. 7. However, the portable terminal 50 can configure the setting with any set content to the target image forming apparatus similarly to the performance illustrated in FIG. 5. The device management system 10 stores the set contents in the set content database 34a of the cloud server 30 even when the portable terminal 50 configures the setting with any set content to the target image forming apparatus.

The image forming apparatus can change the set content via the operation unit of the image forming apparatus itself even when it is not the time of the initial setting illustrated in FIG. 5. When changing the set content via the operation unit of the image forming apparatus itself, the image forming apparatus may configure the setting with any set content illustrated in FIG. 5. The image forming apparatus may cause the display unit of the image forming apparatus itself to display the set contents, which have been filtered by the device management apparatus 20 corresponding to the attribution of the image forming apparatus itself illustrated in FIGS. 6 and 7, to configure the setting with the set content selected from the displayed set contents.

While in the above-described embodiment the device management system 10 is necessary to receive the number information by the user as described above, the number information may be a fixed value such as 10 for example.

The device management system 10 may receive the attribution automatically depending on the kind of the attribution. For example, the image forming apparatus can detect the temperature with a built-in sensor to save the labor of the user for inputting the temperature. The same applies to the humidity while a description was given of the temperature.

While in the above-described embodiment the device management system 10 includes the device management apparatus 20 and the cloud server 30 separately, the device management apparatus 20 may also serve as the cloud server 30.

While in the above-described embodiment the device management system 10 includes the image forming apparatus as the electronic device, the device management system 10 may include an electronic device other than the image forming apparatus, such as a PC.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A device management apparatus, comprising:
a set content collection circuit that collects set contents of a plurality of electronic devices; and
a set content notification circuit that notifies the set contents collected by the set content collection circuit; wherein
the set content notification circuit notifies a specific number of set contents with highest ranks in counts of electronic devices having an identical set content.

2. The device management apparatus according to claim 1, further comprising:
a setting execution circuit that configures a setting to a target electronic device; wherein
when at least one set content is specified among the plurality of set contents, the setting execution circuit configures the settings for the target electronic device with the specified set contents, the plurality of set contents being notified by the set content notification circuit.

3. The device management apparatus according to claim 1, wherein:
the set content collection circuit collects the set content associating with an attribution of the electronic device; and
when an attribution is specified, the set content notification circuit notifies a set content associated with the specified attribution.

4. The device management apparatus according to claim 1, wherein:
the electronic device has performance modes including a normal mode for an ordinary performance and a maintenance mode exclusive for a maintenance; and
the set content is a content settable only in the maintenance mode among the normal mode and the maintenance mode.

5. A non-transitory computer-readable recording medium storing a control program to control a device management apparatus, the control program causing the device management apparatus to function as:
a set content collection circuit that collects set contents of a plurality of electronic devices; and
a set content notification circuit that notifies the set contents collected by the set content collection circuit; wherein
the set content notification circuit notifies a specific number of set contents with highest ranks in counts of electronic devices having an identical set content.

6. A device management method, comprising:
collecting set contents of a plurality of electronic devices via a set content collection circuit; and
notifying the set contents collected by the set content collection step via a set content notification circuit; wherein
the notifying includes notifying a specific number of set contents with highest ranks in counts of electronic devices having an identical set content via the set content notification circuit.
